(19) United States
(12) Patent Application Publication
(10) Pub. No.: US 2010/0070166 A1
(43) Pub. Date: Mar. 18, 2010

(54) ROUTING IN MAPPING SYSTEMS

(75) Inventor: Roman Krzanowski, White Plains, NY (US)

Correspondence Address: VERIZON;PATENT MANAGEMENT GROUP, 1320 North Court House Road, 9th Floor, ARLINGTON, VA, 22201-2909, US

(73) Assignee: Verizon Corporate Services Group Inc., Basking Ridge, NJ (US)

(21) Appl. No.: 12/210,448

(22) Filed: Sep. 15, 2008

(51) Int. Cl. G01C 21/20

(52) U.S. Cl. 701/202

(57) ABSTRACT

A method may include receiving a start location and an end location for determining a route, determining an areal feature for at least one of inclusion or exclusion in determining the route, determining the route based on the areal feature, and providing the determined route.

### BACKGROUND

Current mapping systems used to provide directional information for a user either via a dedicated Global Positioning System (GPS) device, a wireless telephone (e.g., a cellular telephone), a computer, or some other type of handheld, portable, stationary, or mobile device, may calculate a best route to a specific destination based on criterion, such as shortest route, quickest route, type of road, etc. However, the selected best route may direct the user through an area that is not desirous to the user or the best route may fail to direct the user through an area that is desirous to the user.

### BRIEF DESCRIPTION OF THE DRAWINGS

FIGS. 1A and 1B are diagrams illustrating concepts associated with route selection based on the inclusion and/or exclusion of areal features;

FIG. 2 is a diagram illustrating an exemplary environment in which concepts associated with route selection based on the inclusion and/or exclusion of areal features may be implemented;

FIG. 3A is a diagram illustrating exemplary external components of the exemplary user device depicted in FIG. 2;

FIG. 3B is a diagram illustrating exemplary internal components of the exemplary user device depicted in FIG. 2;

FIG. 3C is a diagram illustrating exemplary functional components of the exemplary user device depicted in FIG. 2 that may provide route selection based on the inclusion and/or exclusion of areal features;

FIG. 4 is a flow diagram illustrating an exemplary process for selecting a route based on the inclusion and/or exclusion of areal features;

FIGS. 5A and 5B are diagrams illustrating examples of routes selected based on the inclusion and/or exclusion of areal features; and

FIG. 5C is a diagram illustrating an exemplary user interface for route selection.

### DETAILED DESCRIPTION OF PREFERRED EMBODIMENTS

The following detailed description refers to the accompanying drawings. The same reference numbers in different drawings may identify the same or similar elements. Also, the following description does not limit the invention.

The concepts described herein relate to providing a route selection scheme that may be based on the inclusion and/or exclusion of areal features. For example, an areal feature may include a geographic feature (e.g., a lake, a desert, a forested area, a mountainous area, etc.), an administrative feature (e.g., a town, a city, a county, a state, etc.), a conceptual feature (e.g., a downtown area, a suburb area, a municipal area, a shopping district, etc.), a point of interest (POI) (e.g., a public or national park, a zoo, a mall, etc.). The inclusion and/or the exclusion of areal features may supplement other criterion (e.g., quickest route, shortest route, etc.) in route selection. It will be appreciated that the terms “inclusion” and “exclusion” are intended to be broadly interpreted to include, for example, complete or entire inclusion or exclusion and partial inclusion or exclusion, respectively.

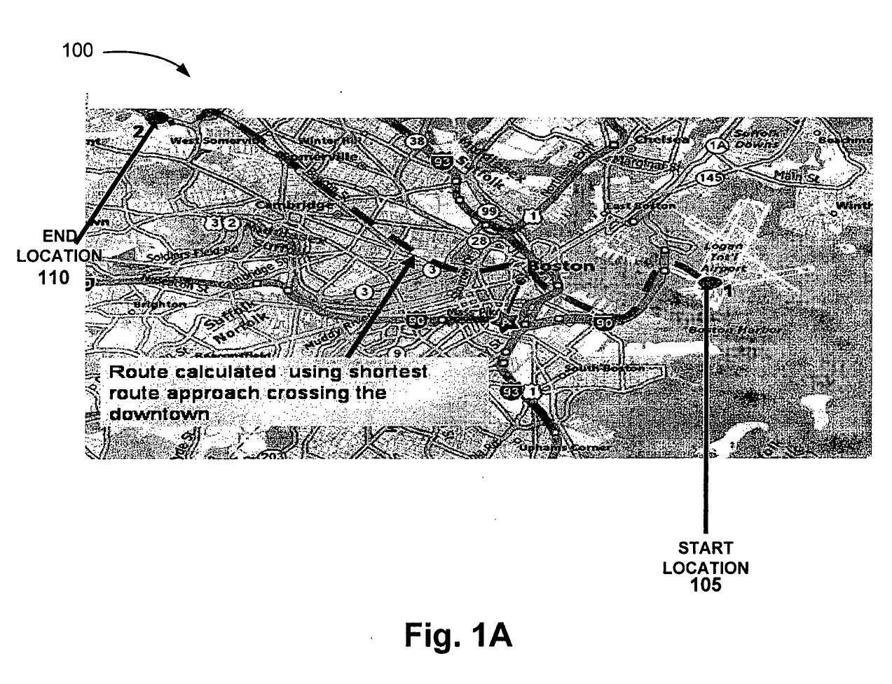

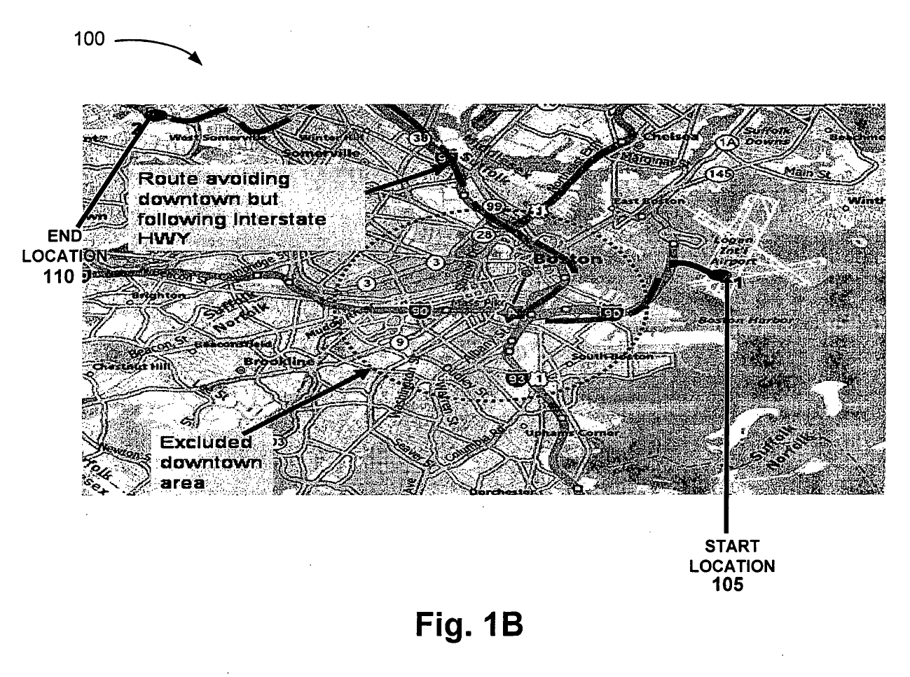

FIGS. 1A and 1B are diagrams illustrating exemplary routes that exemplify the concepts described herein. The routes include a start location 105 and an end location 110. The routes are depicted as an overlay to a map 100.

As illustrated in FIG. 1A, map 100 includes a shortest route calculated from start location 105 to end location 110. The shortest route (indicated by a dashed line) traverses through a downtown area of Boston.

In FIG. 1B, map 100 includes a shortest route calculated from start location 105 to end location 110 based on the exclusion of an areal feature. The areal feature excluded corresponds to the downtown area (as indicated by a dotted circle). In this case, the shortest route (indicated by a dashed line) avoids (e.g., a partial exclusion) the downtown area by following an Interstate highway instead of completely excluding the downtown area by following roads outside of the downtown area.

As a result of the foregoing, routes may be calculated based on the inclusion and/or exclusion of areal features. The inclusion and/or exclusion of areal features may supplement other criterion (e.g., shortest route, quickest route, type of road, by a certain time, etc.) that is typically used in a route selection process. Since concepts have been broadly described in relation to FIGS. 1A and 1B, variations to the above concepts will be discussed further below.

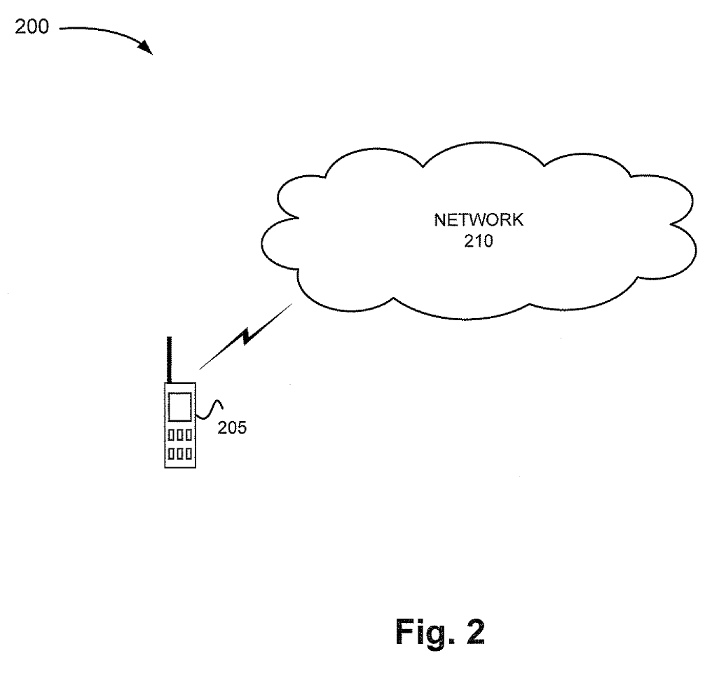

FIG. 2 is a diagram of an exemplary environment 200 where route selection based on the exclusion and/or inclusion of areal features may be implemented. As illustrated, FIG. 2 includes a user device 205 and a network 210. User device 205 may be communicatively coupled to network 210.

User device 205 may include, for example, a device capable of providing a user with a route. For example, user device 205 may include a GPS-based device, a computer, a portable device, a handheld device, a mobile device, a stationary device, a wireless telephone, a personal digital assistant (PDA), a web-browsing device, an in-car navigation system, a navigation device, and/or some other type of computational, communicational, and/or geographical information device. User device 205 may permit a user to select criterion to be used in calculating the route. As will be described in greater detail below, the criterion may include the inclusion and/or the exclusion of an areal feature. The areal criterion may be coupled with other criterion (e.g., shortest route, quickest route, type of road (e.g., major road, toll road, highway, freeway, etc.), etc.

Network 210 may include, for example, the Internet, an Intranet, a local area network (LAN), a wide area network (WAN), a telephone network (e.g., a Public Switched Telephone Network (PSTN), a wireless network, a GPS network, a cellular network, and/or a combination of networks. Although not illustrated, network 210 may include one or more devices that perform one or more operations associated with a route selection based on the inclusion and/or the exclusion of an areal feature. For example, network 210 may include a driving direction server, a GPS, a geographical information system (GIS), etc.

Although FIG. 2 illustrates an exemplary environment 200, in other implementations, environment 200 may include additional, fewer, or different devices and/or networks. For example, user device 205 may include a stand-alone device.

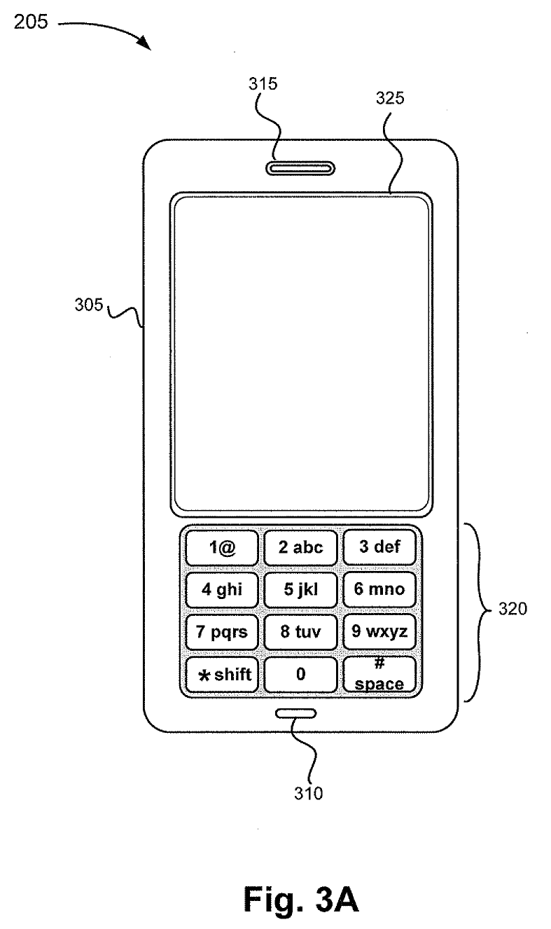

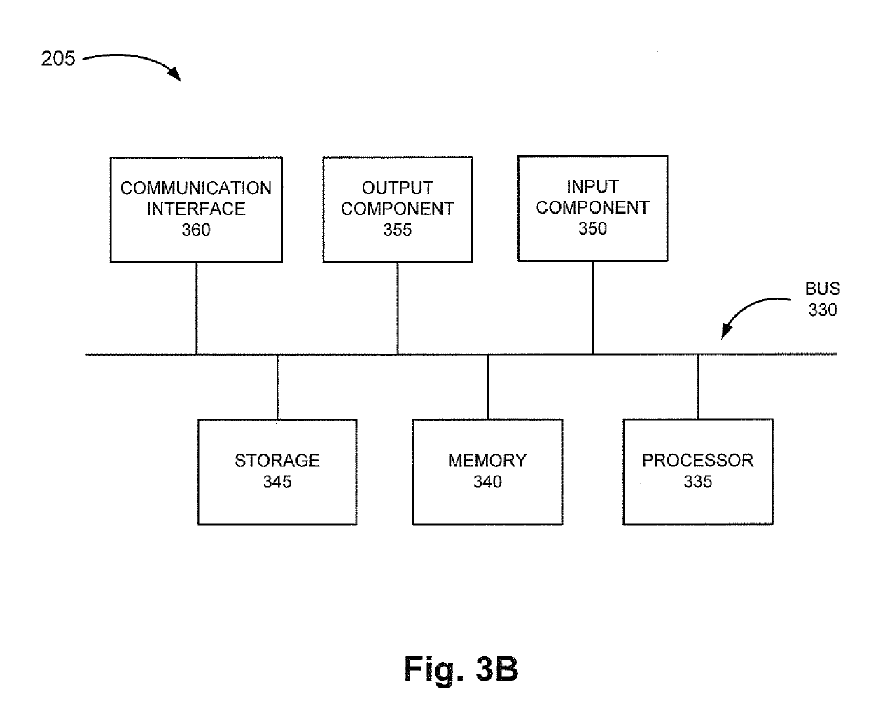

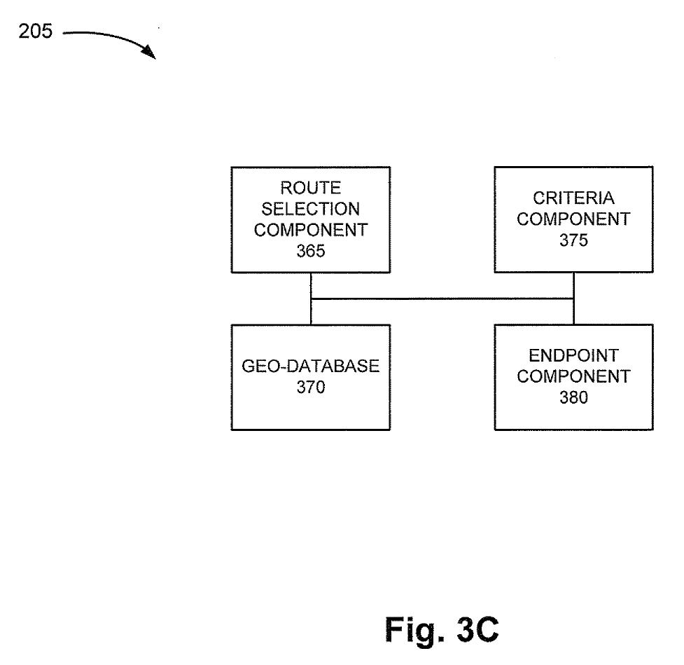

FIG. 3A is a diagram illustrating a front view of exemplary external components of user device 205. As illustrated, user device 200 may include a housing 305, a microphone 310, a speaker 315, a keypad 320, and a display 325.

Housing 305 may include a structure to contain components of device 205. For example, housing 305 may be formed from plastic or metal and may support microphone 310, speaker 315, keypad 320, and display 325.

Microphone 310 may include a component capable of transducing a sound wave to a corresponding electrical signal. For example, a user may speak into microphone 310 during a telephone call. Speaker 315 may include a component capable of transducing an electrical signal to a corresponding sound wave. For example, a user may listen to music or listen to a calling party through speaker 315.

Keypad 320 may include a component capable of providing input to device 205. Keypad 320 may include a standard telephone keypad. Keypad 320 may also include one or more special purpose keys. In one implementation, each key of keypad 320 may be, for example, a pushbutton. A user may utilize keypad 320 for entering information, such as text or a phone number, or activating a special function.

Display 325 may include a component capable of providing visual information. For example, display 325 may include a liquid crystal display (LCD), a plasma display panel (PDP), a field emission display (FED), a thin film transistor (TFT) display, or some other type of display technology. Display 325 may display, for example, text, images, and/or video information to a user. Display 325 may include a touch screen.

Although FIG. 3A illustrates exemplary components, in other implementations, user device 205 may include additional, fewer, or different components.

FIG. 3B is a diagram illustrating exemplary internal components of user device 205. As illustrated, user device 205 may include a bus 330, a processor 335, a memory 340, storage 345, an input component 350, an output component 355, and a communication interface 360.

Bus 330 may include a path that permits communication among the components of device 205. For example, bus 330 may include a system bus, an address bus, a data bus, and/or a control bus. Bus 330 may also include bus drivers, bus arbiters, bus interfaces, and/or clocks.

Processor 335 may include a component that interprets and/or executes instructions and/or data. For example, processor 335 may include a general-purpose processor, a microprocessor, a data processor, a co-processor, a network processor, an application specific integrated circuit (ASIC), a controller, a programmable logic device, a chipset, a field programmable gate array (FPGA), or some other component that may interpret and/or execute instructions and/or data.

Memory 340 may include a component that stores data, an application, and/or instructions related to the operation and use of user device 205. For example, memory 340 may include a random access memory (RAM), a dynamic random access memory (DRAM), a static random access memory (SRAM), a synchronous dynamic random access memory (SDRAM), a ferroelectric random access memory (FRAM), a read only memory (ROM), a programmable read only memory (PROM), an erasable programmable read only memory (EPROM), an electrically erasable programmable read only memory (EEPROM), and/or a flash memory.

Storage 345 may include a component that stores data, an application and/or instructions related to the operation and use of user device 205. For example, storage 345 may include a hard disk (e.g., a magnetic disk, an optical disk, a magneto-optic disk, etc.) or another type of computer-readable medium, along with a corresponding drive. The term “computer-readable medium” is intended to be broadly interpreted to include a physical or a logical memory device. Memory 340 and/or storage 345 may also include a storing device external to and/or removable from user device 205, such as a Universal Serial Bus (USB) memory stick, a hard disk, etc.

Input component 350 may include a component that permits a user and/or another component to input information to user device 205. For example, input component 350 may include as a keyboard, a keypad, a touch screen, a touchpad, a mouse, a button, a switch, a microphone, an input port, voice recognition logic, and/or some other type of visual and/or auditory input component. Output component 355 may include a component that outputs information to a user and/or another component. For example, output component 355 may include a display, a speaker, one or more light emitting diodes (LEDs), an output port, a vibrator, and/or some other type of visual, auditory, and/or tactile output component.

Communication interface 360 may include a component that enables user device 205 to communicate with other components and/or systems. For example, communication interface 360 may include an Ethernet interface, an optical interface, a coaxial interface, a radio interface, or the like that permit user device 205 to communicate with network 210.

Although FIG. 3B illustrates exemplary components, in other implementations, user device 205 may include additional, fewer, or different components. For example, user device 205 may include a GPS receiver and/or some other type of location-identifying component.

FIG. 3C is a diagram illustrating exemplary functional components capable of performing one or more operations associated with the concepts described herein. In one embodiment, one or more of the exemplary functional components may be implemented by application software that is executed by processor 335 of user device 205. However, it will be appreciated that the functional components may be implemented in connection with a combination of components of user device 205, as an additional component(s) to those previously described in connection with user device 205, and/or implemented in a device(s) other than user device 205. For example, one or more of the functional components may be implemented in one or more devices in network 210. As illustrated, the functional components may include a route selection component 365, a geo-database 370, a criteria component 375, and an endpoint component 380.

Route selection component 365 may select a route. Route selection component 365 may select a route based on criteria (e.g., quickest route, shortest route, type of road, by a certain time, etc.) and areal features. Route selection component 365 may select a route based on endpoint information. Endpoint information may include a starting point and a destination point.

Geo-database 370 may store map information. For example, geo-database 370 may include geographical data (e.g., roads, points of interest (POI), cities, landmarks, etc.) and spatial data (e.g., for spatial queries, spatial operations, etc.). Geo-database 370 may also include relational information (e.g., object-relational data) between geographical data.

Geo-database 370 may also include areal features. As previously described, an areal feature may include, for example, a geographic feature (e.g., a lake, a desert, a forested area, a mountainous area, etc.), an administrative feature (e.g., a town, a city, a county, a state, etc.), a conceptual feature (e.g., a downtown area, a suburb area, a municipal area, a shopping district, etc.), and/or a point of interest (POI) (e.g., a public or national park, a zoo, a mall, etc.). Geo-database 370 may define an areal feature based on various attributes (e.g., population, size of area, etc.).

Criteria component 375 may provide criteria in which a route is selected. The criteria may include, for example, shortest route, quickest route, the type of road, by a certain time, etc. Additionally, criteria component 375 may permit a route to be selected based on the inclusion and/or exclusion of areal features. Criteria component 375 may be a part of a user interface in which a user desiring a route may select the criteria in which route selection is based.

Endpoints component 380 may provide the endpoints for route selection. For example, the endpoints may correspond to a starting location and a destination location. Depending on user device 205, the starting location may be determined based on GPS and/or some other form of location-based identifying technique (e.g., cellular, triangulation, multilateration, etc.). Endpoint component 380 may be a part of a user interface in which a user desiring a route may enter a starting location and a destination location.

Although FIG. 3C illustrates exemplary functional components, in other implementations, user device 205 may include additional, fewer, or different functional components. In still other implementations, one or more components of device 205 may perform one or more other tasks described as being performed by one or more other components of device 205. The connections between the functional components are exemplary.

Described below is an exemplary process for route selection based on the inclusion and/or exclusion of areal features. The process will be described as being performed by user device 205. However, it will be appreciated that one or more operations for determining a route based on the inclusion and/or exclusion of an areal feature may be performed by a device other than user device 205. For example, as previously described, network 210 may include devices that may perform one or more operations associated with the concepts described herein.

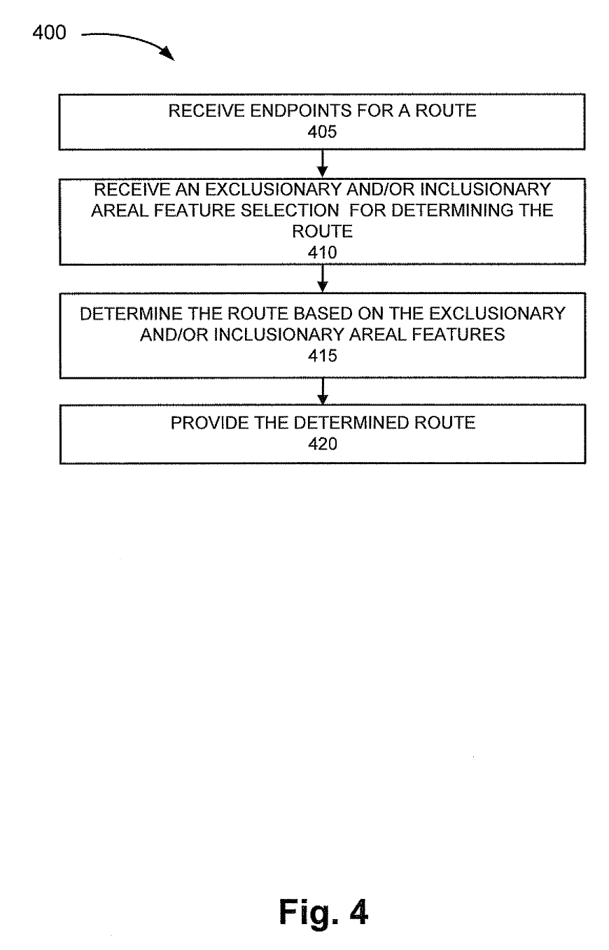

FIG. 4 is a flow diagram illustrating an exemplary process 400 for route selection based on the inclusion and/or the exclusion of areal features. In addition to FIG. 4, process 400 may be described in reference to the previously described figures.

Process 400 may begin with receiving endpoints for a route (block 405). In some circumstances, a user may provide a start location and a destination location. For example, a user may enter a start location and a destination location via keypad 320. In other circumstances, user device 205 may determine a current location (e.g., based on GPS, etc.) and utilize the current location as a start location. The start and destination locations may be received by endpoint component 380.

An exclusionary and/or inclusionary areal feature selection may be received (block 410). For example, a user may select (e.g., from a user interface) an areal feature to be included in and/or excluded from a route. For example, a menu of a user interface (not illustrated) may permit a user to select from a list or a category of areal features which may be included and/or excluded in the route selection process. As previously described, an areal feature may include, for example, a geographic feature (e.g., a lake, a desert, a forested area, a mountainous area, etc.), an administrative feature (e.g., a town, a city, a county, a state, etc.), a conceptual feature (e.g., a downtown area, a suburb area, a municipal area, a shopping district, etc.), and/or a point of interest (POI) (e.g., a public or national park, a zoo, a mall, etc.). A user may be able to select such things as “exclude large urban areas,” “include national parks,” “exclude downtown,” or “exclude city.” Additionally, or alternatively, a user may be able to specify certain attributes of a particular areal feature to include and/or exclude. For example, a user may be able to select “exclude large urban areas” where the population is over “150,000” and/or where the area is greater than “2 square miles.” Additionally, or alternatively, a user may be able to select a combination of areal features. For example, a user may be able to select such things as “exclude large urban areas” but “include national parks.” Additionally, or alternatively, a user may be able to select other types of combinations, such as, for example, “exclude large urban areas but include Interstate highways,” “exclude downtown but include state highways,” etc. It will be appreciated that these examples are not intended to be exhaustive and that other areal features, combination of areal features, and other combinations, such as, for example, a combination of a conventional route criterion (e.g., shortest route, quickest route, etc.) and an areal feature(s), may be implemented.

The route based on the exclusionary and/or inclusionary areal features may be determined (block 415). For example, route selection component 365 may search for a route based on the inclusion and/or exclusion of an areal feature. Route selection component 365 may utilize endpoint information (e.g., from endpoint component 380) and/or other criteria (e.g., shortest route, quickest route, etc.) for determining a route. Route selection component 365 may determine a route based on a search of geo-database 370. Various factors may influence whether the areal feature is completely or partially included or excluded. For example, the road topologies between the endpoints and proximate to the areal feature, other criteria (e.g., shortest route, quickest route, etc.), etc. Route selection component 365 may select an optimum route.

The determined route may be provided (block 420). For example, user device 205 may display a route on display 325. Additionally, or alternatively, the route may be saved as a file. The file may be printed, etc.

Although FIG. 4 illustrates an exemplary process 400, in other implementations, fewer, additional, or different processes may be performed.

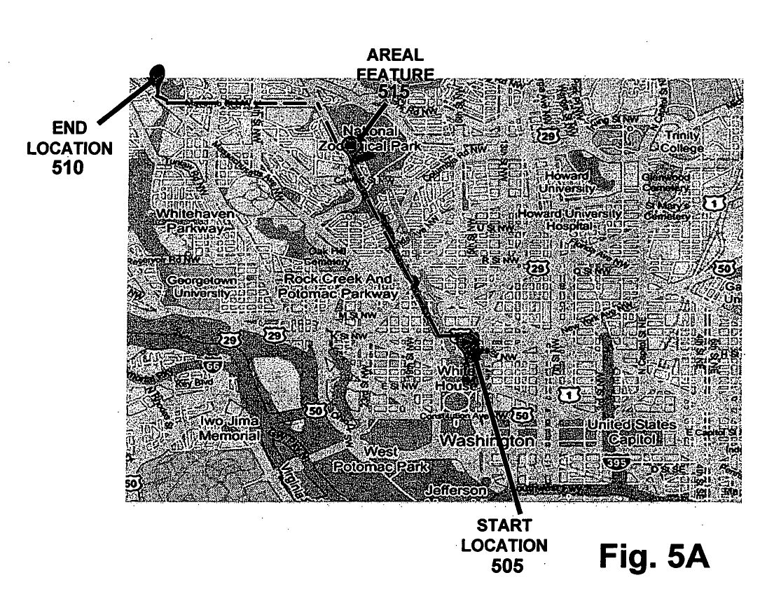

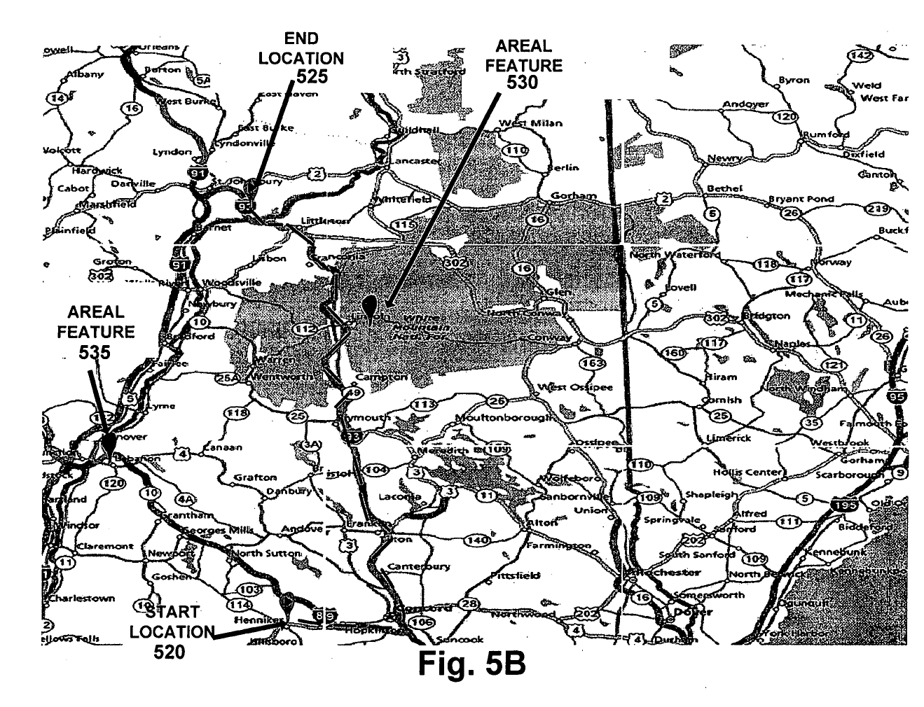

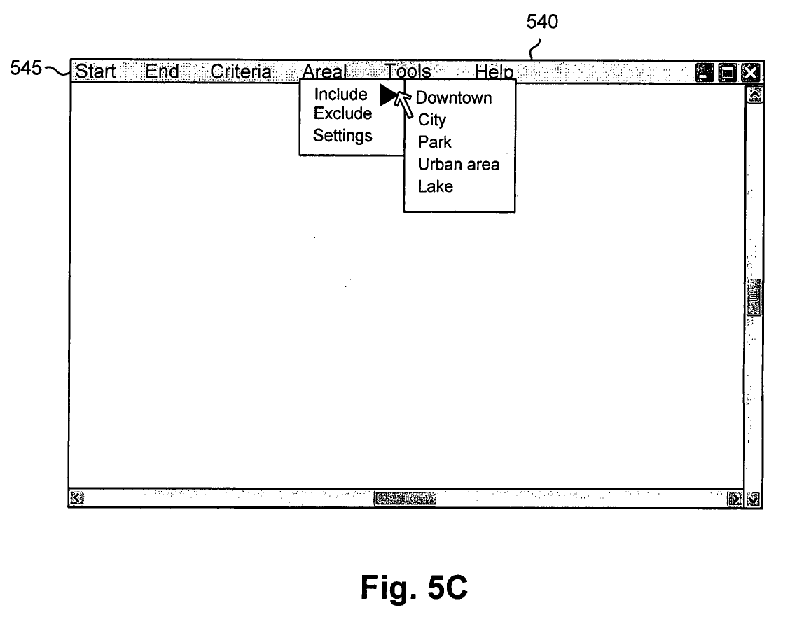

FIGS. 5A and 5B are diagrams illustrating exemplary routes based on the inclusion and/or exclusion of areal features. As illustrated in FIG. 5A, assume that a user desires a route from a start location 505 (e.g., The White House) to an end location 510 (e.g., American University). Additionally, the user desires the route to include an areal feature 515 (e.g., National Zoo). The route may be determined based on the inclusion of areal feature 515. The route (illustrated as a dashed line) may be displayed to the user on display 325 of user device 205. In one implementation, areal feature 515 may indicated by a marker. In other implementations, areal feature 515 may not be indicated by a marker.

In another example, as illustrated in FIG. 5B, assume that a user desires a route from a start location 520 (e.g., Henniken) to an end location 525 (e.g., St. Johnsbury). Additionally, the user desires the route to include an areal feature 530 (e.g., a National Forest) and to exclude an areal feature 535 (e.g., Lebanon). The route may be determined based on the inclusion of area feature 530 and the exclusion of areal feature 535. Similarly, the route (illustrated by a dashed line) may be displayed to the user on display 325 of user device 205.

It will be appreciated that the routes depicted in FIGS. 5A and 5B may be determined based on additional criteria (e.g., shortest route, quickest route, etc.). That is, the inclusion and/or the exclusion of an areal feature may supplement traditional route selection criteria. FIG. 5C illustrates an exemplary user interface 540 for route selection. As illustrated, user interface 540 may include, for example, a menu 545 that allows a user to enter a start location, an end location, criteria (e.g., shortest route, quickest route, etc.), and select an areal feature for inclusion and/or exclusion. For example, as illustrated in FIG. 5C, the user may be able select from a list of categories of areal features, such as, for example, downtown, city, park, urban area, etc. User interface 540 may also permit the user to enter a specific areal feature (e.g., a specific city (i.e., its name), a specific park, etc.). Additionally, or alternatively, user interface 540 may permit the user to modify and/or add additional areal features within a new and/or existing category of areal feature. For example, the user may be able to modify how an areal feature (e.g., downtown) is defined in geo-database 370 by modifying parameters associated with this areal feature (e.g., number of people, size of area, density, etc.).

Although FIGS. 5A and 5B illustrate exemplary routes and FIG. 5C illustrates an exemplary user interface, in other implementations, the graphics, visual indicators, arrangement, etc., may be different.

According to the concepts described herein, route selection may be performed based on the inclusion and/or exclusion of areal features. The inclusion and/or exclusion of areal features may supplement existing route selection criteria (e.g., shortest route, quickest route, etc.). A user may avoid and/or include certain geographic areas (i.e., an areal feature) in a route.

The foregoing description of implementations provides illustration, but is not intended to be exhaustive or to limit the implementations to the precise form disclosed. For example, although it has been described that a user may enter and/or select information (e.g., start location, areal feature, etc.), it will be appreciated that such information may be entered and/or selected once, and subsequently remain pre-configured for a subsequent route selection. Additionally, or alternatively, a user may be permitted to configure preferences of areal features so that the user may not need to select an areal feature each time a route selection is requested. For example, if the user prefers routes that include forested areas, the user may be permitted to configure that this areal feature is included (e.g., when possible or given other criteria constraints) for subsequent routes. Additionally, or alternatively, while the concepts described herein for route selection has depicted maps with roads, etc., the route selection described herein is not intended to be limited to a user that may travel a route by a vehicle, such as a car.

The term “may” is used throughout this application and is intended to be interpreted, for example, as “having the potential to,” “configured to,” or “being able to”, and not in a mandatory sense (e.g., as “must”). The terms “a,” “an,” and “the” are intended to be interpreted to include one or more items. Where only one item is intended, the term “one” or similar language is used. Further, the phrase “based on” is intended to be interpreted as “based, at least in part, on,” unless explicitly stated otherwise. The term “and/or” is intended to be interpreted to include any and all combinations of one or more of the associated list items.

In addition, while a series of blocks has been described with regard to the process illustrated in FIG. 4, the order of the blocks may be modified in other implementations. Further, non-dependent blocks may be performed in parallel.

It will be apparent that the device(s) described herein may be implemented in many different forms of software, firmware, and hardware in the implementations illustrated in the figures. The actual software code or specialized control hardware used to implement these concepts does not limit the invention. Thus, the operation and behavior of a device(s) was described without reference to the specific software code—it being understood that software and control hardware can be designed to implement the concepts based on the description herein.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential to the implementations described herein unless explicitly described as such.

What is claimed is:

1. A method, comprising:
receiving a start location and an end location for determining a route;
determining an areal feature for at least one of inclusion or exclusion in determining the route;
determining the route based on the areal feature; and
providing the determined route.

2. The method of claim 1, where the areal feature corresponds to a geographic area.

3. The method of claim 1, where the areal feature includes at least one of a municipal area, a downtown area, an urban area, a public or national park, a city, a county, a state, a forested area, or a geographic feature.

4. The method of claim 1, further comprising:
determining the route based on at least one of a shortest route criterion or a quickest route criterion.

5. The method of claim 1, further comprising:
determining the route based on a type of road.

6. The method of claim 1, where the providing comprises displaying the route.

7. The method of claim 6, where the displayed route indicates the areal feature by a marker.

8. The method of claim 1, further comprising:
receiving a user selection of the areal feature.

9. A system comprising:
one or more components to:
receive a start location and an end location for determining a route;
receive an areal feature to be utilized for determining the route;
determine the route based on the start location, the end location and the areal feature; and
output the determined route.

10. The system of claim 9, where the system comprises a user device.

11. The system of claim 9, where the areal feature can be at least one of an inclusionary areal feature or an exclusionary areal feature.

12. The system of claim 9, where the one or more components are further configured to:
receive a route selection criterion, where the route selection criterion includes at least one of a quickest route, a shortest route, a type of road, or a time of arrival.

13. The system of claim 9, where the areal feature includes one or more parameters that are user configurable.

14. A computer-readable medium containing instructions executable by a processor, the computer-readable medium storing one or more instructions for:
determining a start location and an end location for calculating a route;
receiving a route selection criterion;
receiving a selection of an areal feature;
calculating the route based on the start location, the end location, the route selection criterion and the areal feature; and
providing the determined route.

15. The computer-readable medium of claim 14, where the areal feature is either included or excluded from the determined route.

16. The computer-readable medium of claim 14, further comprising one or more instructions for providing a user interface for selecting the areal feature.

17. The computer-readable medium of claim 14, where the start location is determined based on a location-identifying system.

18. The computer-readable medium of claim 14, where the areal feature corresponds to a geographic area.

19. The computer-readable medium of claim 14, where the route selection criterion includes one of a shortest route, a quickest route, a type of road, or by a certain time.

20. The computer-readable medium of claim 14, where the providing includes displaying the determined route.
